(19) United States
(12) Patent Application Publication
(10) Pub. No.: US 2016/0139940 A1
(43) Pub. Date: May 19, 2016

(54) SYSTEMS AND METHODS FOR CREATING VIRTUAL MACHINE

(71) Applicant: Quanta Computer Inc., Taoyuan City (TW)

(72) Inventors: Wen-Kuang Chen, Taoyuan City (TW); Chun-Hung Chen, Taoyuan City (TW); Chien-Kuo Hung, Taoyuan City (TW); Tien-Chin Fang, Taoyuan City (TW); Chen-Chung Lee, Taoyuan City (TW)

(21) Appl. No.: 14/635,274

(22) Filed: Mar. 2, 2015

(30) Foreign Application Priority Data
Nov. 14, 2014 (TW) 103139493

(51) Int. Cl. G06F 9/455

(52) U.S. Cl. CPC G06F 9/45533

(57) ABSTRACT

A system for creating virtual machines, adapted to a virtual management platform, includes a configuration module, a selection module, a determination module and a distribution module. The configuration module creates a plurality of virtual sections according to the resource specifications. The selection module selects one of the virtual sections according to the customized specifications. The determination module creates a virtual section-setting profile according to the customized specifications. The determination module further calculates the quantity of the remaining resources of the virtual section, and determines whether the quantity of the customized specifications will exceed the remaining resources or not. When the quantity of the customized specifications does not exceed the quantity of the remaining resources, the distribution module creates a virtual machine in the virtual section according to the virtual section-setting profile.

### CROSS REFERENCE TO RELATED APPLICATIONS

This Application claims priority of Taiwan Patent Application No. 103139493, filed on Nov. 14, 2014, the entirety of which is incorporated by reference herein.

### BACKGROUND OF THE INVENTION

1. Field of the Invention

The application relates in general to a system and method for creating a virtual machine, and in particular to a system and method for creating a virtual machine for automatically distributing the source of the virtual machine in one of the virtual sections.

2. Description of the Related Art

These days, due to the rapid development of technology, Hardware Virtualization is used widely. For the application of the Cloud computing infrastructure service, the source of a computer is virtually divided into a plurality of virtual machine according to the virtualization technology being used. The user can implement different applications on the Cloud computing infrastructure service based on different needs. Due to different requirements, the virtual machine must be created by different mechanisms of the virtualization technology, such as different types of the operating systems. When the user wants to create a virtual machine, the manager will supply a new virtual section according to the specification of the virtual machine. However, that might increase the cost and time wasted in creating a new virtual section, and cause the excessive use of the Virtual IDC. Thus, how to automatically distribute the source of the Virtual IDC and reduce the cost are the problems which need to be solved immediately.

### BRIEF SUMMARY OF INVENTION

An embodiment of the present invention provides a system for creating virtual machines, adapted to a virtual management platform, including a configuration module, a selection module, a determination module and a distribution module. The configuration module creates a plurality of virtual sections according to the resource specifications. The selection module selects one of the virtual sections according to the customized specification. The determination module creates a virtual section-setting profiles according to the customized specifications. The determination module further calculates the quantity of the remaining resources of the virtual section, and determines whether the quantity of customized specifications will exceed the remaining resources or not. When the quantity of the customized specification does not exceed the quantity of the remaining resource, the distribution module creates the virtual machine in the virtual section according to the virtual section-setting profile.

Another embodiment of the present invention provides a method for creating virtual machines, adapted to a virtual management platform. The steps include: creating a plurality of virtual sections according to a plurality of resource specifications; selecting one of the virtual sections according to a customized specification; creating a virtual section-setting profile according to the customized specification; calculating a quantity of remaining resource of the virtual section; determining whether a quantity of the customized specification will exceed the quantity of the remaining resource or not; and creating a virtual machine in the virtual section in the selected virtual section according to the virtual section-setting profile when the quantity of the customized specification does not exceed the quantity of the remaining resource.

### BRIEF DESCRIPTION OF DRAWINGS

The invention can be more fully understood by reading the subsequent detailed description and examples with references made to the accompanying drawings, wherein:

FIG. 1 is a block diagram of a system for creating virtual machine in accordance with an embodiment of the invention;

FIG. 2 is a flow chart of a method for creating virtual machine in accordance with an embodiment of the invention.

### DETAILED DESCRIPTION OF INVENTION

Further areas to which the present systems and methods can be applied will become apparent from the detailed description provided herein. It should be understood that the detailed description and specific examples, while indicating exemplary embodiments of system and method for creating virtual machine, are intended for purposes of illustration only and are not intended to limit the scope of the invention.

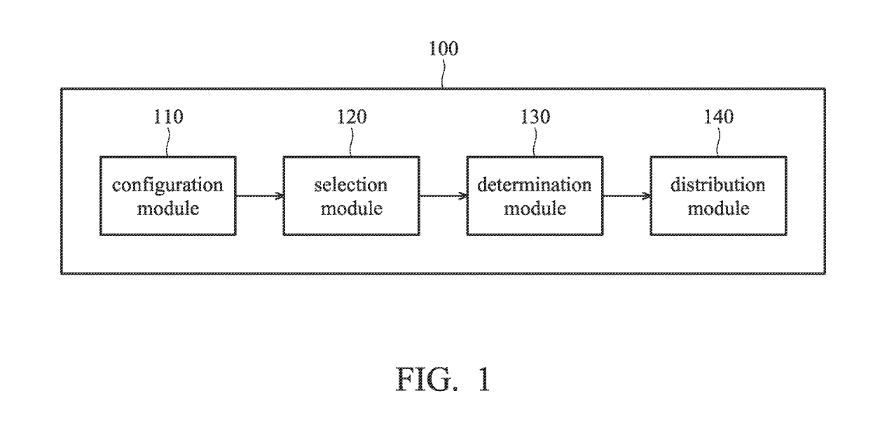

FIG. 1 is a block diagram of the system for creating the virtual machine in accordance with an embodiment of the invention. The system 100 includes a configuration module 110, a selection module 120, a determination module 130 and a distribution module 140. The configuration module 110 creates a plurality of virtual sections according to the resource specifications. The selection module 120 selects one of the virtual sections according to the customized specification. The determination module 130 creates a virtual section-setting profile according to the customized specification, calculates the quantity of the remaining resource of the virtual section, and determines whether the quantity of the customized specification will exceed the remaining resource or not. When the quantity of the customized specification does not exceed the quantity of the remaining resource, the distribution module 140 creates virtual machine in the virtual section according to the virtual section-setting profile.

According to an embodiment of the present invention, the user can input the desired setting into a user interface of the system 100 for automatically creating the virtual machine using the system 100. First, the configuration module 110 will set the resource limitations according to the virtualization technology of the virtual management platform, such as the limitations of CPU, memory, or hard disk, etc. For example, by using the virtualization technology of Hyper-V 2.0, the limited distribution of CPU is 4 due to the Hyper-V 2.0 only supporting 4 CPUs. Further, the configuration module 110 can create a plurality of virtual sections with different resources according to different operating systems. Each virtual section can only implement one type of operating system due to the fact that each virtual section only distributes one authorization code. The system 100 further includes a network resource distribution module (not shown). The configuration module 110 further determines the number of virtual network cards according to the network source (e.g. IP source) distributed by the network resource distribution module. After determining the resource limitations, the configuration module 110 creates the plurality of virtual sections with different specifications.

The selection module 120 selects one of the virtual sections according to the desired setting entered by the user. For example, the selection module 120 calculates the score of each virtual section according to the specification and the status of each virtual section, and selects one of the virtual sections which conforms to the user's needs. It should be noted that the selection module 120 calculates the score according to the original source of each virtual section without considering the current usage of each virtual section.

After selecting the virtual section, the determination module 130 creates the virtual section-setting profile, and determines whether the quantity of the remaining resource is conformed to the desired setting or not. The manager will preset the usage limitation when creating the virtual sections, such as the limitation of the CPU, memories, or the capacity of the hard disk. The determination module 130 determines whether the quantity corresponds to the desired setting and the usage resource will exceed the preset limitation or not. If they are over the preset limitation, the determination module 130 stops creation of the virtual machine and notifies the manager, or waits until the quantity of the remaining resources is greater than the desired setting. Otherwise, if they are not over the preset limitation, the distribution module 140 creates the virtual machine according to the virtual section-setting profile.

According to another embodiment of the present invention, the determination module 130 further determines whether the desired setting assigns a specific network partition or not. When the user does not assign any network partition, the determination module 130 further determines whether the desired setting has been assigned to the specific network partition or not. If it assigns the network partition before, the determination module 130 implements the related setting according to the record. Otherwise, the determination module 130 determines whether the remaining network source is sufficient or not, such as by determining whether the IP source is sufficient for creating the new virtual machine or not. If the IP source is not sufficient, the determination module 130 stops creation of the virtual machine and noticies the manager.

According to another embodiment of the present invention, if the user assigns a specific IP address, the determination module 130 determines whether the IP address is used by other virtual machines or not. If the IP address is used, the determination module 130 notices the manager, and detects the status of the IP address at predetermined intervals for determining whether the IP address can be used or not.

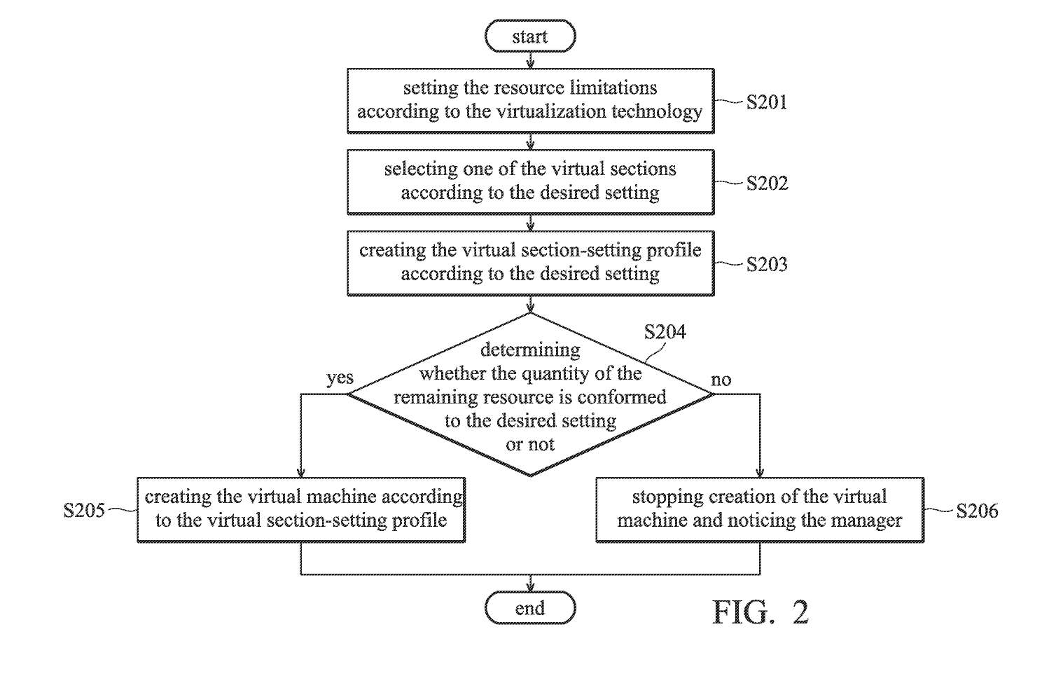

Please refer FIG. 2 with FIG. 1. FIG. 2 is a flow chart of a method for creating virtual machine in accordance with an embodiment of the invention. In step S201, the configuration module 110 sets the resource limitations according to the virtualization technology of the virtual management platform, such as the limitations of CPU, memory, or hard disk, etc. For example, by using the virtualization technology of Hyper-V 2.0, the limited distribution of CPU is 4 due to the Hyper-V 2.0 only supporting 4 CPUs. The configuration module 110 further determines the operating system of the virtual section according to the template, and the number of virtual network cards according to the network source (e.g. IP source) distributed by the network resource distribution module.

After creating the plurality of the virtual sections with different specifications, the method goes to step S202, The selection module 120 selects one of the virtual sections according to the desired setting entered by the user. The selection module 120 calculates the score of each virtual section according to the specification and the status of each virtual section, and selects one of the virtual section which is conformed to the user's need.

At step S203, the determination module 130 creates the virtual section-setting profile according to the desired setting. At step S204, the determination module 130 determines whether the quantity of the remaining resource is conformed to the desired setting or not. The manager will preset the usage limitation when creating the virtual sections, such as the limitation of the CPU, memories, or the capacity of the hard disk. The determination module 130 determines whether the quantity corresponds to the desired setting and the usage resource will exceed the preset limitation or not. If they are not over the preset limitation, the method goes to step 5205, the distribution module 140 creates the virtual machine according to the virtual section-setting profile. Otherwise, if they are over the preset limitation, the method goes to step S206, the determination module 130 stops creation of the virtual machine and notices the manager, or continuously waits until the quantity of the remaining source is greater than the quantity corresponding to the desired setting.

It should be noted that the determination module 130 further determines whether the desired setting assigns a specific network partition or not. When the user does not assign any network partition, the determination module 130 further determines whether the desired setting has been assigned the specific network partition or not. If it assigns the network partition before, the determination module 130 implements the related setting according to the record. Otherwise, the determination module 130 determines whether the remaining network source is sufficient or not, such as determines whether the IP source is enough for creating the new virtual machine or not. If the IP source is not enough, the determination module 130 stops creation of the virtual machine and notices the manager.

According to another embodiment of the present invention, if the user assigns a specific IP address, the determination module 130 determines whether the IP address is used by other virtual machines or not. If the IP address is used, the determination module 130 notices the manager, and detects the status of the IP address at predetermined intervals for determining whether the IP address can be used or not.

As described above, an embodiment of the invention provides a system and method for creating virtual machine, the automated agent can appropriately create the virtual machine in the virtual section according to the specification and the usage of each virtual section, and determines whether the specification of the virtual section is conformed to the need of the virtual machine or not. As a result, the cost of managing can be reduced, and hardware conflicts between the virtual machine and the virtual section can be avoided. Furthermore, the risk of a collapse of the virtual machine due to over usage of the virtual section can also be reduced.

It will be apparent to those skilled in the art that various modifications and variations can be made to the structure disclosed without departing from the scope or spirit of the invention. In view of the foregoing, it is intended that the present invention covers modifications and variations of this invention, provided they fall within the scope of the following claims and their equivalents.

What is claimed is:

1. A system for creating virtual machines, adapted to a virtual management platform, comprising:
a configuration module, configured to create a plurality of virtual sections according to a plurality of resource specifications;
a selection module, configured to select one of the virtual sections according to customized specifications;
a determination module, configured to create a virtual section-setting profile according to the customized specifications, calculate a quantity of remaining resources of the virtual section, and determine whether a quantity of the customized specifications will exceed the quantity of remaining resources or not; and
a distribution module, configured to create a virtual machine in the selected virtual section according to the virtual section-setting profile when the quantity of the customized specification does not exceed the quantity of the remaining resources.

2. The system as claimed in claim 1, wherein the resource specification comprises specifications for operating system, central processing unit, memory, hard disk or network card.

3. The system as claimed in claim 1, wherein the distribution module stops creation of the virtual machine when the quantity of the customized specification exceeds the quantity of the remaining resource.

4. The system as claimed in claim 1, further comprising:
a network resource distribution module, configured to distribute and IP resource according to the resource specification of the virtual section.

5. The system as claimed in claim 4, wherein the distribution module further determines remaining network source of the IP source, and the distribution module stops creation of the virtual machine when the quantity of the customized specification exceeds the quantity of the remaining network resource.

6. A method for creating virtual machines, adapted to a virtual management platform, comprising:
creating a plurality of virtual sections according to a plurality of resource specifications;
selecting one of the virtual sections according to customized specifications;
creating a virtual section-setting profile according to the customized specifications;
calculating a quantity of remaining resources of the virtual section;
determining whether a quantity of the customized specifications will exceed the quantity of the remaining resource or not; and
creating a virtual machine in the virtual section in the selected virtual section according to the virtual section-setting profile when the quantity of the customized specifications does not exceed the quantity of the remaining resources.

7. The method as claimed in claim 6, wherein the resource specification comprises specifications for operating system, central processing unit, memory, hard disk or network card.

8. The method as claimed in claim 6, further comprising:
stopping creation of the virtual machine when the quantity of the customized specification exceeds the quantity of the remaining resource.

9. The method as claimed in claim 6, further comprising:
distributing IP source according to the resource specification of the virtual section.

10. The method as claimed in claim 9, further comprising:
determining remaining network source of the IP source; and
stopping creation of the virtual machine when the quantity of the customized specification exceeds the quantity of the remaining network resource.
